(19) United States
(12) Patent Application Publication
(10) Pub. No.: US 2019/0169367 A1
(43) Pub. Date: Jun. 6, 2019

(54) SEMI-CRYSTALLINE THERMOPLASTIC POLYESTER FOR PRODUCING AN AEROSOL CONTAINER

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/321,343

(22) PCT Filed: Aug. 2, 2017
(86) PCT No.: PCT/FR2017/052168

§ 371 Date: Jan. 28, 2019

(30) Foreign Application Priority Data
Aug. 2, 2016 (FR) 16 57492

(51) Int. Cl. C08G 63/672; B29C 49/00; B29C 49/12; B29C 49/06

(52) U.S. Cl. CPC C08G 63/672; B29C 49/0005; B29K 2067/00; B29C 49/06; B29C 49/12

(57) ABSTRACT

Use of a semi-crystalline thermoplastic polyester for producing an aerosol container, said polyester having at least one 1,4:3,6-dianhydrohexitol unit (A), at least one alicyclic diol unit (B) other than the 1,4:3,6-dianhydrohexitol units (A), and at least one terephthalic acid unit (C), wherein the molar ratio (A)/[(A)+(B)] is at least 0.05 and at most 0.30, said polyester being free of non-cyclic aliphatic diol units or comprising a molar amount of non-cyclic aliphatic diol units, relative to the totality of monomeric units in the polyester, of less than 5%, and with a reduced viscosity in solution (25° C.; phenol (50 wt. %): ortho-dichlorobenzene (50 wt. %); 5 g/L of polyester) greater than 70 mL/g.

### FIELD OF THE INVENTION

The present invention relates to the field of aerosol plastics and concerns the use of a semicrystalline thermoplastic polyester comprising at least one 1,4:3,6-dianhydrohexitol unit for producing an aerosol container

### TECHNICAL BACKGROUND OF THE INVENTION

Plastics have become inescapable in the mass production of objects. Indeed, their thermoplastic character enables these materials to be transformed at a high rate into all kinds of objects.

Certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units, used for example in the production of films.

However, for certain applications or under certain usage conditions, it is necessary to improve certain properties, especially impact strength or else heat resistance. This is why glycol-modified PETs (PETgs) have been developed. They are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties.

Other modified PETs have also been developed by introducing, into the polyester, 1,4:3,6-dianhydrohexitol units, especially isosorbide (PEIT). These modified polyesters have higher glass transition temperatures than the unmodified PETs or PETgs comprising CHDM. In addition, 1,4:3,6-dianhydrohexitols have the advantage of being able to be obtained from renewable resources such as starch.

Another problem with these PEITs is that they may have insufficient impact strength properties. In addition, the glass transition temperature may be insufficient for the production of certain plastic objects.

In order to improve the impact strength properties of the polyesters, it is known from the prior art to use polyesters in which the crystallinity has been reduced. As regards isosorbide-based polyesters, mention may be made of application US2012/0177854, which describes polyesters comprising terephthalic acid units and diol units comprising from 1 to 60 mol % of isosorbide and from 5 to 99% of 1,4-cyclohexanedimethanol which have improved impact strength properties. As indicated in the introductory section of this application, the aim is to obtain polymers in which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(1,4-cyclohexanedimethylene-co-isosorbide)terephthalate (PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanol: Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% isosorbide and 71% CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide.

Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, despite the use of prolonged synthesis times.

Thus, despite the modifications introduced into PETs, there is still a constant need for novel polyesters which have improved properties, in particular in the field of aerosol containers where the constraints and specifications that must be adhered to are demanding.

In the aerosol field, it has precisely often been proposed to replace the metal used in the container with plastics, and in particular PET.

Unfortunately, at the current time, aerosol containers made of plastic, and in particular those made of PET, can have a tendency to creep and can leak or burst under the pressures exerted during filling, storage or the test phases.

Furthermore, during production, stresses internal to the material can release and create weaker zones, thereby resulting, in the end, in a crack in the container. This phenomenon is commonly known as “stress cracking” and is disadvantageous for producing aerosol containers.

Despite everything, solutions have been proposed in order to adapt PET to the production of aerosol containers.

For example, application US 2013/0037580 A1 proposes a plastic aerosol container having a thermally crystallized neck, said neck being configured to receive an aerosol valve assembly and an expanded strain-oriented aerosol container forming a body integral with the neck finish. The thermally crystallized neck thus makes it possible to obtain a better strength of the aerosol container.

Application WO 2007/051229 proposes reinforcing the container by means of a collar and thus describes a container for dispensing an aerosol product or pressurized product. The container contains a body formed of PET, a collar attached to the body and a dispensing valve attached to the collar. The collar may be snap-fitted or screwed onto the body in a manner such that it straddles the opening about the neck of the body, thus forming a shaped lip therearound.

Despite the presence of the solutions, the latter lead to a considerable increase in costs and additional steps, which is not satisfactory for proposing competitive alternatives, and PET is still not optimally suited to the production of aerosol containers. Indeed, the solutions proposed do not relate to polyester as such.

There is therefore still a need to provide novel plastics, in particular novel thermoplastic polyesters advantageously allowing use for the production of an aerosol container and in particular having improved properties.

Furthermore, at the current time, the European specifications comprise a multitude of drastic tests for which conventional PETs are not entirely satisfactory for the production of an aerosol container because of insufficient heat resistance and an insufficient glass transition temperature.

It is thus to the applicant's credit to have found that this need can, against all expectations, be achieved with a semicrystalline thermoplastic polyester based on isosorbide and not having ethylene glycol, while it was hitherto known that the latter was essential for the incorporation of said isosorbide.

Indeed, by virtue of a particular viscosity and a particular ratio of units, the semicrystalline thermoplastic polyester used according to the present invention proves to be particularly advantageous for use in the production of aerosol containers, in particular by virtue of a high glass transition temperature.

The use of a thermoplastic polyester according to the invention thus makes it possible to reduce the stress cracking phenomena in the aerosol container produced, while the same time improving the final properties obtained, in particular in terms of pressure resistance and resistance to high temperatures.

### SUMMARY OF THE INVENTION

A first subject of the invention relates to the use of a semicrystalline thermoplastic polyester for producing an aerosol container, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
wherein the (A)/[(A)+(B)] molar ratio is at least 0.05 and at most 0.30,
   said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 70 ml/g.

A second subject of the invention relates to a process for producing an aerosol container based on the semicrystalline thermoplastic polyester described above.

Finally, a third subject of the invention relates to an aerosol comprising the semicrystalline thermoplastic polyester previously described.

### DETAILED DESCRIPTION OF THE INVENTION

Thus, a subject of the invention is the use of a semicrystalline thermoplastic polyester for producing an aerosol container, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
   wherein the (A)/[(A)+(B)] molar ratio is at least 0.05 and at most 0.30 and the reduced solution viscosity being greater than 70 ml/g.

The semicrystalline thermoplastic polyester is free of non-cyclic aliphatic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

“(A)/[(A)+(B)] molar ratio” is intended to mean the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A).

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic diol unit is advantageously less than 1%. Preferably, the polyester is free of any aliphatic non-cyclic diol units and more preferentially it is free of ethylene glycol.

Despite the low amount of aliphatic non-cyclic diol, and hence of ethylene glycol, used for the synthesis, a semicrystalline thermoplastic polyester is surprisingly obtained which has a high reduced solution viscosity and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol and may be isosorbide, isomannide, isoidide, or a mixture thereof. Preferably, the 1,4:3,6-dianhydrohexitol (A) is isosorbide.

Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. Preferentially, the alicyclic diol (B) is 1,4-cyclohexanedimethanol.

The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A), i.e. (A)/[(A)+(B)] is at least 0.05 and at most 0.30. Advantageously, this ratio is at least 0.1 and at most 0.28, more particularly this ratio is at least 0.15 and at most 0.25.

A semicrystalline thermoplastic polyester that is particularly suitable for the production of an aerosol container comprises:
a molar amount of 1,4:3,6-dianhydrohexitol units (A) ranging from 2.5 to 14 mol %;
a molar amount of alicyclic diol units (B) other than the 1,4:3,6-dianhydrohexitol units (A) ranging from 31 to 42.5 mol %;
a molar amount of terephthalic acid units (C) ranging from 45 to 55 mol %.

The amounts of different units in the polyester may be determined by 1H NMR or by chromatographic analysis of the mixture of monomers resulting from complete hydrolysis or methanolysis of the polyester, preferably by 1H NMR.

Those skilled in the art can readily find the analysis conditions for determining the amounts of each of the units of the polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The semicrystalline thermoplastic polyesters used according to the invention have a melting point ranging from 210 to 295° C., for example from 240 to 285° C.

Furthermore, the semicrystalline thermoplastic polyesters have a glass transition temperature ranging from 85 to 120° C., for example from 90 to 115° C.

The glass transition temperatures and melting points are measured by conventional methods, especially using differential scanning calorimetry (DSC) using a heating rate of 10° C./min. The experimental protocol is described in detail in the examples section below.

Advantageously, the semicrystalline thermoplastic polyester has a heat of fusion of greater than 10 J/g, preferably greater than 20 J/g, the measurement of this heat of fusion consisting in subjecting a sample of this polyester to a heat treatment at 170° C. for 16 hours, then in evaluating the heat of fusion by DSC by heating the sample at 10° C./min.

The semicrystalline thermoplastic polyester used according to the invention in particular has a lightness L* greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced solution viscosity of said semicrystalline thermoplastic polyester is greater than 70 ml/g and preferably less than 130 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/I.

This test for measuring reduced solution viscosity is, due to the choice of solvents and the concentration of the polymers used, perfectly suited to determining the viscosity of the viscous polymer prepared according to the process described below.

The semicrystalline nature of the thermoplastic polyesters used according to the present invention is characterized when the latter, after a heat treatment of 16 h at 170° C., have X-ray diffraction lines or an endothermic melting peak in differential scanning calorimetry (DSC) analysis.

The semicrystalline thermoplastic polyester as defined above has many advantages for the production of an aerosol container.

Indeed, by virtue in particular of the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and at most 0.30 and of a reduced solution viscosity greater than 70 ml/g and preferably less than 130 ml/g, the semicrystalline thermoplastic polyesters have a better heat resistance and a better glass transition temperature, which allows the aerosol containers produced from the latter to have a better pressure resistance while the same time reducing the stress cracking phenomena.

For the purposes of the present invention, an aerosol container is a container essentially consisting of plastic and may for example be a bottle, a flask or else a tank. The container is preferably a tank. The aerosol container subsequently allows the production of the aerosol as such.

The aerosol containers according to the invention may be directly produced from the melt state after polymerization of the semicrystalline thermoplastic polyester.

According to one alternative, the semicrystalline thermoplastic polyester may be packaged in a form that is easy to handle, such as pellets or granules, before being used for producing an aerosol container. Preferentially, the semicrystalline thermoplastic polyester is packaged in the form of granules, said granules being advantageously dried before conversion into the form of an aerosol container. The drying is carried out so as to obtain granules having a residual moisture content of less than 300 ppm, preferentially less than 200 ppm, for instance approximately 134 ppm.

The production of an aerosol container can be carried out according to techniques known to those skilled in the art. For example, the production can be carried out by extrusion biaxial-stretch blow molding or by injection stretch blow molding (ISBM).

The production is preferably carried out by injection stretch blow molding. According to this method, the semicrystalline thermoplastic polyester is injected so as to form a preform. The neck of the preform already has its definitive shape and constitutes the part which is used to hold the future container during the blow molding operation. If necessary, the preform is reheated and enclosed in a blow-molding mold having the desired shape. The mold may be formed from two half-shells having imprints on the lower face making it possible to give the future container particular surface appearances.

When the preform is introduced into the mold, a stretching rod stretches the material axially, and pre-blow molding is carried out at a pressure of a few bar. The final blow molding is carried out by injection of compressed air. Thus, the polymer chains are oriented both along a longitudinal axis of the future container and radially, and the polyester cools on contact with the mold, thereby fixing the container in its final shape.

This biaxial orientation makes it possible to obtain aerosol containers with improved mechanical properties.

The form and the volume of the aerosol container produced depend on the features of the mold used for the blow molding. Regarding the volume, it may vary from a few cm³ to a few dm³, especially from 50 cm³ to 1500 m³ and preferably from 100 cm³ to 1000 cm³, and even more particularly from 100 cm³ to 500 cm³, such as, for example, 300 cm³.

According to one particular embodiment, the semicrystalline thermoplastic polyester previously defined is used in combination with one or more additional polymers for the production of an aerosol container.

The additional polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and blendtures of these polymers.

The additional polymer may also be a polymer which makes it possible to improve the impact properties of the polyester, especially functional polyolefins such as functionalized ethylene or propylene polymers and copolymers, core-shell copolymers or block copolymers.

One or more additives may also be added during the production of an aerosol container from the semicrystalline thermoplastic polyester in order to give it particular properties.

Thus, by way of example of an additive, mention may be made of opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The additive may also be a UV-resistance agent such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimasorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example Melapur™: melapur 200), or else aluminum or magnesium hydroxides.

A second subject of the invention relates to a process for producing an aerosol container, said process comprising the following steps of:
provision of a semicrystalline thermoplastic polyester as defined above,
preparation of said aerosol container from the semicrystalline thermoplastic polyester obtained in the preceding step.

The preparation step can be carried out according to the methods known to those skilled in the art which are conventionally implemented for producing aerosol containers.

Thus, by way of example, the preparation can be carried out by extrusion biaxial-stretch blow molding or by injection stretch blow molding. The production is preferably carried out by injection stretch blow molding.

A third subject of the invention relates to aerosol containers comprising the semicrystalline thermoplastic polyester described above. The aerosol containers according to the invention may also comprise an additional polymer and/or one or more additives as defined above.

The semicrystalline thermoplastic polyester that is particularly suited to the production of an aerosol container may be prepared by a synthesis process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing, into the reactor, a catalytic system;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum, at a temperature ranging from 278 to 300° C. so as to form the polyester, advantageously from 280 to 290° C., for example 285° C.;
a step of recovering the semicrystalline thermoplastic polyester.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease ramps, in steps, or else using a combination of pressure decrease ramps and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting of the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer in accordance with the use according to the invention for the production of a container.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Finally, the synthesis process comprises a step of recovering the polyester resulting from the polymerization step. The semicrystalline thermoplastic polyester thus recovered can then be formed as described above.

According to one variant of the synthesis process, a step of increasing the molar mass is carried out after the step of recovering the semicrystalline thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably the latter has a heat of fusion of greater than 10 J/g, preferably greater than 20 J/g, the measurement of this heat of fusion consisting in subjecting a sample of this polymer of lower reduced solution viscosity to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester.

The SSP step may be carried out in an inert atmosphere, for example under nitrogen or under argon or under vacuum.

According to a second variant of the production process, the post-polymerization step is carried out by reactive extrusion of the semicrystalline thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in any of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline thermoplastic polyester obtained in the extrusion step.

During the extrusion, the temperature inside the extruder is adjusted so as to be at above the melting point of the polymer. The temperature inside the extruder may range from 150 to 320° C.

The invention will be understood more clearly by means of the examples and figures below, which are intended to be purely illustrative and do not in any way limit the scope of the protection.

### EXAMPLES

The properties of the polymers were studied via the following techniques:

Reduced Solution Viscosity

The reduced solution viscosity is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/l.

DSC

The thermal properties of the polyesters were measured by differential scanning calorimetry (DSC): The sample is first heated under a nitrogen atmosphere in an open crucible from 10° C. to 320° C. (10° C.min⁻¹), cooled to 10° C. (10° C.min⁻¹), then heated again to 320° C. under the same conditions as the first step. The glass transition temperatures were taken at the mid-point of the second heating. Any melting points are determined on the endothermic peak (onset) at the first heating.

Similarly, the enthalpy of fusion (area under the curve) is determined at the first heating.

For the illustrative examples presented below, the following reagents were used: 1,4-Cyclohexanedimethanol (99% purity, mixture of cis and trans isomers)

Isosorbide (purity>99.5%) Polysorb® P from Roquette Freres

Terephthalic acid (99+% purity) from Acros

Irganox® 1010 from BASF AG

Dibutyltin oxide (98% purity) from Sigma-Aldrich

### Example 1: Preparation of a Semicrystalline Thermoplastic Polyester and Use for Production of an Aerosol Container

A: Polymerization

Thus, 1432 g (9.9 mol) of 1,4-cyclohexanedimethanol, 484 g (3.3 mol) of isosorbide, 2000 g (12.0 mol) of terephthalic acid, 1.65 g of Irganox 1010 (antioxidant) and 1.39 g of dibutyltin oxide (catalyst) are added to a 7.5 l reactor. To extract the residual oxygen from the isosorbide crystals, four vacuum-nitrogen cycles are performed once the temperature of the reaction medium is between 60° C. and 80° C. The reaction mixture is then heated to 275° C. (4° C./min) under 6.6 bar of pressure and with constant stirring (150 rpm) until a degree of esterification of 87% is obtained. (Estimated on the basis of the mass of distillate collected). The pressure is then reduced to 0.7 mbar over the course of 90 minutes according to a logarithmic gradient and the temperature is brought to 285° C.

These vacuum and temperature conditions were maintained until an increase in torque of 12.1 Nm relative to the initial torque is obtained.

Finally, a polymer rod is cast via the bottom valve of the reactor, cooled to 15° C. in a heat-regulated water bath and chopped in the form of granules of about 15 mg.

The resin thus obtained has a reduced solution viscosity of 80.1 ml/g.

The ¹H NMR analysis of the polyester shows that the final polyester contains 17.0 mol % of isosorbide relative to the diols.

With regard to the thermal properties, the polyester has a glass transition temperature of 96° C., a melting point of 253° C. with an enthalpy of fusion of 23.2 J/g.

The granules are then used in a solid-state post-condensation step.

For this purpose, the granules are crystallized beforehand for 2 h in an oven under vacuum at 170° C.

The solid-state post-condensation step is then carried out on 10 kg of these granules for 20 h at 210° C. under a stream of nitrogen (1500 l/h) in order to increase the molar mass of these granules. The resin thus has, after solid-state condensation, a reduced solution viscosity of 103.4 ml·g⁻¹.

B—Forming by Injection Stretch Blow Molding (ISBM)

The granules of the polyester obtained in the preceding step are dried at 140° C. under nitrogen in order to achieve residual moisture contents of less than 300 ppm. In this example, the moisture content of the granules is 134 ppm.

The injection is carried out on a Husky single-cavity press with shutters.

The granules, kept under anhydrous conditions, are introduced into the hopper of the injection press and the injection parameters are detailed in table 1 below:

TABLE 1

| Parameters | Units | Values |
|---|---|---|
| Introduction zone | ° C. | 220 |
| temperature | | |
| Temperature of the | ° C. | 275/275/260/260 |
| molten plastic | | |
| (nozzle/tube) | | |
| Mold temperature | ° C. | 50 |
| Injection speed | mm/s | 80 |
| Holding pressure | bar | 29 |
| Holding time | s | 15 |
| Cooling time | s | 15 |

After the injection, the preforms obtained have a weight of 23 g and have a reinforced neck specific to hot filling.

The preforms thus injected are then blow molded in a mold which has the final shape of the aerosol container.

After the blow molding, the containers obtained are used to produce an aerosol which is then filled with a pressurized gas. No deformation is observed and the container maintains its shape perfectly. Furthermore, the containers exhibit no stress cracking even after 48 h following filling with a solution containing 2% citronellol in water.

The semicrystalline thermoplastic polyesters according to the invention are thus particularly advantageous for producing an aerosol container and thus constitute a very good alternative to the polymers already present on the market.

### Example 2: Preparation of a Semicrystalline Thermoplastic Polyester and Use for Production of a Bottle

A: Preparation

A second semicrystalline polyester P2 according to the invention was prepared according to the same procedure as example 1. The amounts of the various compounds were adjusted so as to obtain the polyester P2 having 25 mol % of isosorbide.

The amounts were determined by ¹H NMR and are expressed as percentage relative to the total amount of diols in the polyester.

The reduced solution viscosity of the polyester P2 is 79 ml/g.

B—Forming of the Bottle by Injection Stretch Blow Molding (ISBM)

The granules of the polyester P2 obtained in the polymerization step A are then dried before injection for 6 h at 150° C. and thus have a moisture content of 0.129% by weight.

The injection is carried out on a Husky single-cavity press with shutters.

The granules, kept under anhydrous conditions, are introduced into the hopper of the injection press and the injection parameters are detailed in table 2 below:

TABLE 2

| Parameters | Units | Values |
|---|---|---|
| Screw diameter | mm | 35 |
| L/D Ratio | / | 23 |
| Injection temperature | ° C. | 290/280/270/260/250 |
| (nozzle/tube) | | |
| Mold temperature | ° C. | 50 |
| Loading speed | mm/s | 100 |
| Injection speed | cm³/s | 40/128 |
| Injection pressure | bar | 1250 |
| Holding pressure | bar | 900 |
| Backpressure | bars | 75 |
| Holding time | s | 15 |
| Cooling time | s | 12 |

After the injection, the preforms obtained have a weight of 23.7 g and have a reinforced neck specific to filling under pressure.

The preforms produced were then blow molded in a mold in order to obtain 0.5 l bottles.

The machine used for the blow molding has the general characteristics below:

| Characteristics | Values | |
|---|---|---|
| Maximum product volume | 2.5-5 | l |
| Maximum preform height | 200 | mm |
| Preform wall thickness | 1-4 | mm |
| Maximum product diameter | 170 | mm |
| Maximum product height | 350 | mm |
| Production capacity | 500-800 | Units/hour |

The blow molding of the preforms was then carried out according to the following parameters:

| Parameters | Values | |
|---|---|---|
| Soft temperature | 86° | C. |
| Mold temperature | 25° | C. |
| Stretch delay | 0.05 | s |
| Blown delay | 0.2 | s |
| First blow molding | 0.3 | s |
| Second blow molding | 4 | s |
| Discharge | 1 | s |

The bottles obtained have a uniform appearance and no surface deformation is observed with the naked eye. After filling with a pressurized gas, the bottles maintain their shape perfectly and do not exhibit any stress cracking even after 48 h following filling with a solution containing 2% citronellol in water.

The semicrystalline thermoplastic polyester according to the invention is thus perfectly suitable for producing aerosol containers.

1-19. (canceled)

20. An aerosol container, comprising a semicrystalline thermoplastic polyester comprising:
at least one 1,4:3,6-dianhydrohexitol unit (A);
at least one alicyclic diol unit (B) other than the 1,4:3,6-dianhydrohexitol units (A); and
at least one terephthalic acid unit (C);
wherein the (A)/[(A)+(B)] molar ratio is at least 0.05 and at most 0.30;
said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 70 ml/g.

21. The aerosol container according to claim 20, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

22. The aerosol container according to claim 20, wherein the 1,4:3,6-dianhydrohexitol (A) is isosorbide.

23. The aerosol container according to claim 20, wherein the polyester does not contain any aliphatic non-cyclic diol units, or comprises a molar amount of aliphatic non-cyclic diol units, relative to all the monomer units of the polyester, of less than 1%.

24. The aerosol container according to claim 20, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

25. The aerosol container according to claim 20, wherein the aerosol container comprises one or more additional polymers and/or one or more additives.

26. A method for the production of an aerosol container, said method comprising the following steps:
provision of a semicrystalline thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] molar ratio is at least 0.05 and at most 0.30, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/l of polyester) of said polyester being greater than 70 ml/g; and
preparation of said aerosol container from the semicrystalline thermoplastic polyester obtained in the preceding step.

27. The method according to claim 26, wherein the preparation is carried out by the injection stretch blow molding method.

28. The method according to claim 26, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

29. The method according to claim 26, wherein the 1,4:3,6-dianhydrohexitol (A) is isosorbide.

30. The method according to claim 26, wherein the polyester does not contain any aliphatic non-cyclic diol units, or comprises a molar amount of aliphatic non-cyclic diol units, relative to all the monomer units of the polyester, of less than 1%.

31. The method according to claim 26, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

32. The method according to claim 26, wherein the aerosol container comprises one or more additional polymers and/or one or more additives.
